(19) United States
(12) Patent Application Publication
(10) Pub. No.: US 2024/0316820 A1
(43) Pub. Date: Sep. 26, 2024

(54) Inertial Force Wood Cutting Device

(71) Applicant: YONGKANG MAXPOWER TECHNOLOGY CO., LTD., Zhejiang Province (CN)

(72) Inventor: Xuancong Jin, Zhejiang Province (CN)

(21) Appl. No.: 18/209,131

(22) Filed: Jun. 13, 2023

(30) Foreign Application Priority Data
Mar. 24, 2023 (CN) 202310299163.3
Mar. 24, 2023 (CN) 202320606915.1

(51) Int. Cl. B27L 11/00; B02C 18/24; B02C 21/02

(52) U.S. Cl. CPC B27L 11/005; B02C 18/24; B02C 21/02

(57) ABSTRACT

The inertial force wood cutting device includes a trailer and a fuel engine which is fixed to the trailer by bolts. A cutting cabin is fixed to the trailer by bolts. A first and second rotating shaft are rotatably arranged in the cutting cabin. At least two cutting blades are arranged on the first and second rotating shaft in a sleeving manner. A second and first rotating shaft gear are fixedly arranged at ends of the first and second rotating shaft through keys. The fuel engine drives the flywheel to rotate through the driving belt. The flywheel will be meshed and driven by the first and second rotating shaft gear and a gear coaxial with the flywheel. When the flywheel reaches a certain rotating speed, a powerful inertial force will be generated. Wood is fed from the feeding hopper, and wood moves down to be cut by the cutting blades.

### CROSS REFERENCE

This application takes priority from and claims the benefit of Chinese Patent Application No. 202310299163.3 filed on Mar. 24, 2023, and Chinese Utility Model application Ser. No. 202320606915.1 filed on Mar. 24, 2023, the contents of which are herein incorporated by reference.

### TECHNICAL FIELD

The present disclosure relates to the technical field of wood cutting devices, and in particular, to an inertial force wood cutting device.

### BACKGROUND

The existing wood cutting equipment realizes shearing by increasing torque after reducing a speed of a driver through a conventional gearbox. However, such a technical solution has a limited shearing force, the gearbox has relatively high economic cost, the assembling of the equipment is more complex, and in addition, it is difficult for the equipment to perform autonomous protection at the first time when a machine is overloaded.

### SUMMARY

A technical problem to be solved by the present disclosure is that: in order to overcome the problems above, an inertial force wood cutting device is provided, which solves the problems above.

The present disclosure solves the technical problems by adopting the following technical solutions:

An inertial force wood cutting device includes a trailer and a fuel engine which is fixed to the trailer by bolts. A cutting cabin is also fixed to the trailer by bolts. A first rotating shaft and a second rotating shaft are rotatably arranged in the cutting cabin. At least two cutting blades are arranged on the first rotating shaft and the second rotating shaft in a sleeving manner. A second rotating shaft gear and a first rotating shaft gear which are meshed with each other are fixedly arranged at ends of the first rotating shaft and the second rotating shaft through keys. A rotating shaft is also rotatably arranged on the cutting cabin, and the parts, extending out of the cutting cabin, of two ends of the rotating shaft are fixedly connected with flywheels through keys. A gear which is meshed with the first rotating shaft gear is also connected to the rotating shaft through a key. The flywheel is driven by the fuel engine through a driving belt.

Preferably, a tensioning arm is also hinged to the trailer. A tensioning wheel is rotatably arranged at a front end of the tensioning arm. A cylindrical side surface of the tensioning wheel is abutted against a back surface of the driving belt.

Preferably, a tensioning arm is also hinged to the trailer. A tensioning wheel is rotatably arranged at a front end of the tensioning arm. A cylindrical side surface of the tensioning wheel is abutted against a back surface of the driving belt.

Preferably, a spring is hooked on the tensioning arm, and the other end of the spring is hooked on a protective shell of the flywheel. The spring tensions the tensioning arm, so that the tensioning wheel is capable of abutting against the back surface of the driving belt.

Preferably, a protective plate is fixed to a front end of a feeding hopper by bolts. A protective tube with a downward opening is fixed to a tail end of a discharging shelter by bolts.

Preferably, the flywheel includes a hard supporting casing and a flywheel shell which is fixed to the exterior of the hard supporting casing in a sleeving manner. The flywheel shell is fixed to the hard supporting casing by bolts.

Preferably, a cavity is formed in the flywheel shell. The cavity in the flywheel shell is capable of being filled with counterweight solution. The specific counterweight solution is non-volatile solution which is stable at room temperature.

Preferably, solenoid valves communicated with an inner cavity in the flywheel shell are annularly and fixedly to an outer wall surface of the solenoid valve at intervals. The solenoid valves are controlled to be on and off through remote control signals. During emergency stop, an emergency stop button is pressed down quickly and a signal for opening the solenoid valves is sent out simultaneously, so that the counterweight solution in the flywheel is discharged quickly to reduce an inertial force quickly: and simultaneously, a braking device performs friction braking on a shaft driven to rotate by the flywheel.

Preferably, a plurality of openings are fixedly formed on outer wall surfaces of the solenoid valves. Flip plates covering the openings are hinged to the outer wall surface of the flywheel. Electromagnets are fixedly arranged at movable ends of the flip plates. The electromagnets are fixed to the outer wall surface of the flywheel through magnetic attraction, and are controlled to be on and off through the remote control signal. After the emergency stop, the electromagnets lose magnetic attraction, so that the flip plates are thrown away under the action of gravity and then the counterweight solution is thrown away quickly to reduce the inertial force of the flywheel and brake quickly

Preferably, the driving belt is a flat belt. A protective shell is fixedly arranged outside the flywheel.

The present disclosure has the advantages and positive effects that: the fuel engine drives the flywheel to rotate through the driving belt. After rotating, the flywheel will be meshed and driven by the second rotating shaft gear, the first rotating shaft gear, and a gear coaxial with the flywheel. When the flywheel reaches a certain rotating speed, a powerful inertial force will be generated. At this time, wood is fed from the feeding hopper, and the wood takes advantage of an opportunity to move down to be cut off by the cutting blades that bite each other. After a biting load is excessive, the driving belt will slide to achieve an effect of protecting equipment actively. Compared with a conventional technical solution of reducing speed and increasing torque through a gearbox, the solution is simple in structure, a required shearing force can be generated quickly, the maintenance is convenient, and the cost is low.

### BRIEF DESCRIPTION OF THE DRAWINGS

The present disclosure is further described below with reference to drawings and embodiments.

FIG. 1 is a schematic structural diagram of the present disclosure;

FIG. 2 is a schematic structural diagram of the present disclosure;

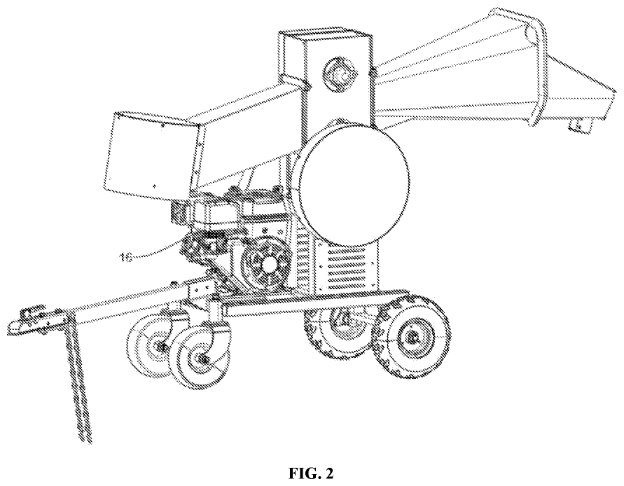

FIG. 3 is a schematic structural diagram of the present disclosure;

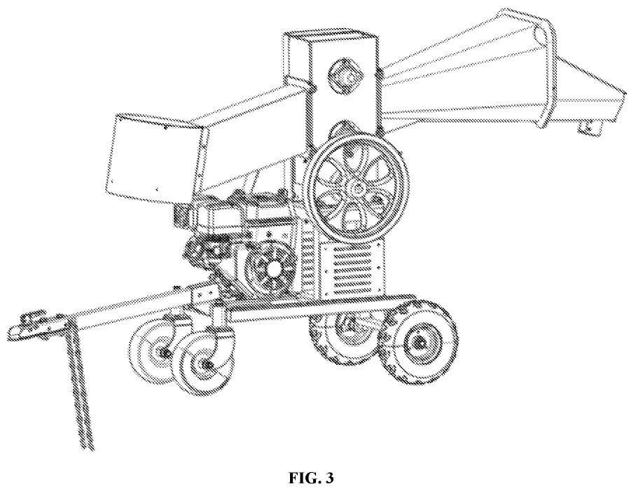

FIG. 4 is a schematic structural diagram of the present disclosure;

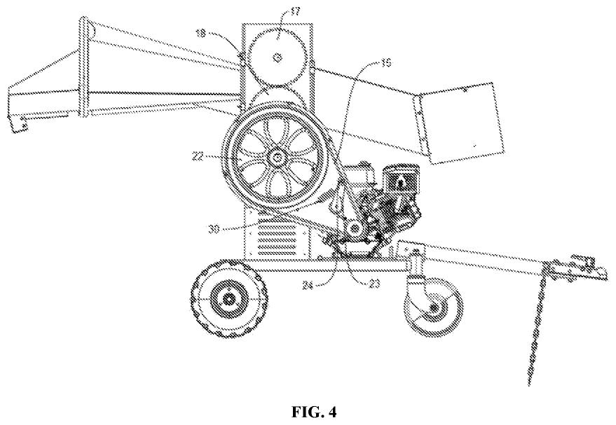

FIG. 5 is a schematic structural diagram of the present disclosure;

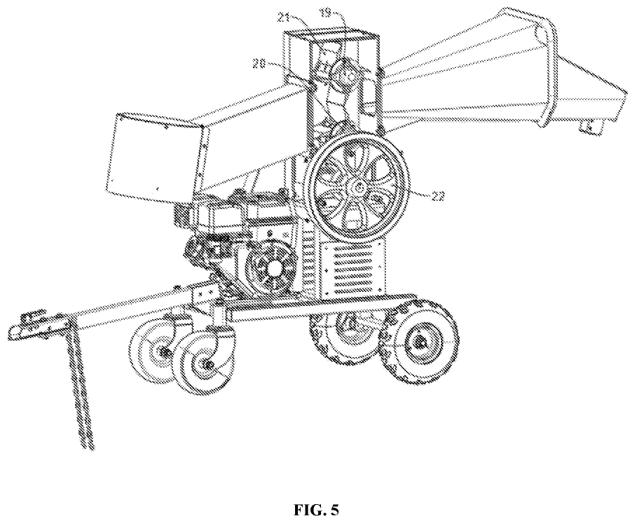

FIG. 6 is a schematic structural diagram of a flywheel 22 of the present disclosure; and

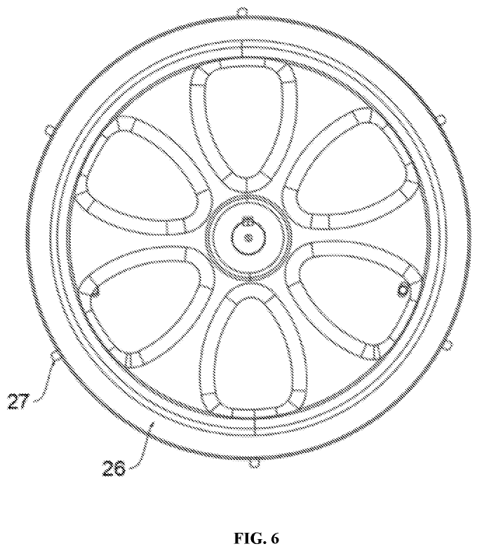

FIG. 7 is a schematic structural diagram of a flywheel 22 of the present disclosure.

Reference signs in the drawings are respectively marked as follows: 10, feeding hopper; 11, discharging shelter; 12, protective tube; 13, protective plate; 14, protective shell; 15, driving belt; 16, fuel engine; 17, second rotating shaft gear; 18, first rotating shaft gear; 19, first rotating shaft; 20, second rotating shaft; 21, cutting blade; 22, flywheel; 23, tensioning arm; 24, tensioning wheel; 25, trailer; 26, flywheel shell; 27, solenoid valve; 28, flip plate; 29, electromagnet; 30, spring; 31, hard supporting casing; and 32, cutting cabin.

### DETAILED DESCRIPTION OF THE EMBODIMENTS

Now, the present disclosure is further described in detail with reference to drawings. These drawings are all simplified schematic drawings, and schematically describe a basic structure of the present disclosure, so they only show components related to the present disclosure.

Embodiments of the present disclosure are further described in detail below with reference to the drawings.

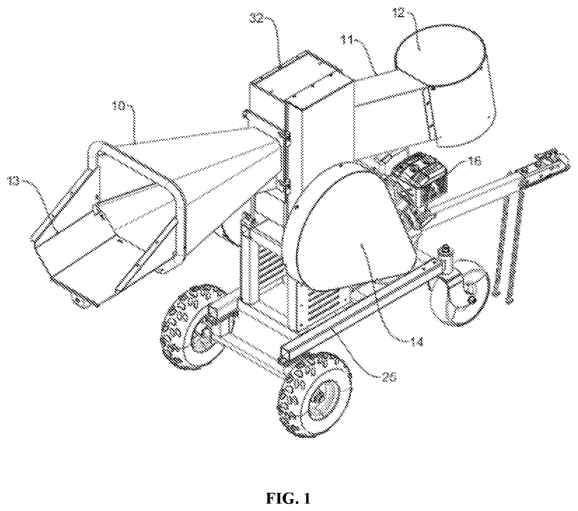

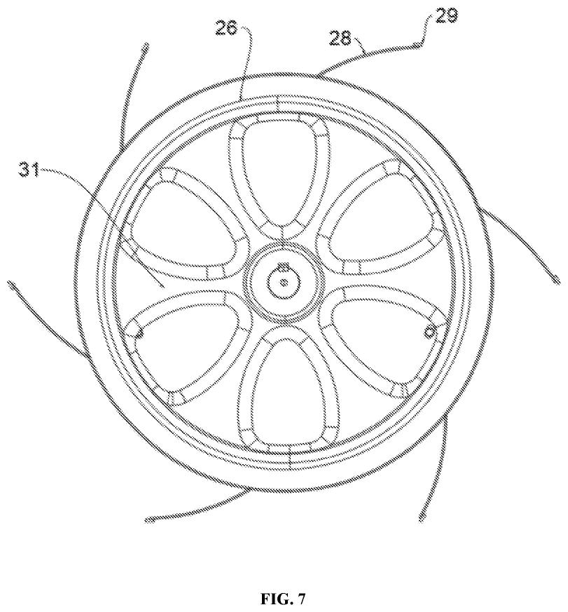

As shown in FIG. 1 and FIG. 7, an inertial force wood cutting device described in the present disclosure includes a trailer 25 and a fuel engine 16 which is fixed to the trailer 25 by bolts. A cutting cabin 32 is also fixed to the trailer 25 by bolts. A first rotating shaft 19 and a second rotating shaft 20 are rotatably arranged in the cutting cabin 32. At least two cutting blades 21 are arranged on the first rotating shaft 19 and the second rotating shaft 20 in a sleeving manner. A second rotating shaft gear 17 and a first rotating shaft gear 18 which are meshed with each other are fixedly arranged at ends of the first rotating shaft 19 and the second rotating shaft 20 through keys. A rotating shaft is also rotatably arranged on the cutting cabin 32, and the parts, extending out of the cutting cabin 32, of two ends of the rotating shaft are fixedly connected with flywheels 22 through keys. A gear which is meshed with the first rotating shaft gear 18 is also connected to the rotating shaft through a key. The flywheel 22 is driven by the fuel engine 16 through a driving belt 15.

Preferably, a tensioning arm 23 is also hinged to the trailer 25. A tensioning wheel 24 is rotatably arranged at a front end of the tensioning arm 23. A cylindrical side surface of the tensioning wheel 24 is abutted against a back surface of the driving belt 15.

Preferably, a spring 30 is hooked on the tensioning arm 23. The other end of the spring 30 is hooked on a protective shell of the flywheel 22. The spring 30 tensions the tensioning arm 23, so that the tensioning wheel 24 is capable of abutting against the back surface of the driving belt 15.

Preferably, a protective plate 13 is fixed to a front end of a feeding hopper 10 by bolts. A protective tube 12 with a downward opening is fixed to a tail end of a discharging shelter 11 by bolts.

Preferably, the flywheel 22 includes a hard supporting casing 31 and a flywheel shell 26 which is fixed to the exterior of the hard supporting casing 31 in a sleeving manner. The flywheel shell 26 is fixed to the hard supporting casing 31 by bolts.

Preferably, a cavity is formed in the flywheel shell 26. The cavity in the flywheel shell 26 is capable of being filled with counterweight solution. Specifically, the counterweight solution is non-volatile solution which is stable at room temperature.

Preferably, solenoid valves 27 communicated with an inner cavity in the flywheel shell 26 are annularly and fixedly to an outer wall surface of the solenoid valve 27 at intervals. The solenoid valves 27 are controlled to be on and off through remote control signals. During emergency stop, an emergency stop button is pressed down quickly and a signal for opening the solenoid valves 27 is sent out simultaneously, so that the counterweight solution in the flywheel 26 is discharged quickly to reduce an inertial force quickly; and simultaneously a braking device performs friction braking on a shaft driven to rotate by the flywheel 22.

Preferably, a plurality of openings are fixedly formed on outer wall surfaces of the solenoid valves 27. Flip plates 28 covering the openings are hinged to the outer wall surface of the flywheel 26. Electromagnets 29 are fixedly arranged at movable ends of the flip plates 28. The electromagnets 29 are fixed to the outer wall surface of the flywheel 26 through magnetic attraction, and are controlled to be on and off through the remote control signal. After the emergency stop, the electromagnets 29 lose magnetic attraction, so that the flip plates 28 are thrown away under the action of gravity and then the counterweight solution is thrown away quickly to reduce the inertial force of the flywheel 26 and brake quickly.

Preferably, the driving belt 15 is a flat belt. A protective shell 14 is fixedly arranged outside the flywheel 22 by bolts.

During specific implementation, the fuel engine 16 drives the flywheel 22 to rotate through the driving belt 15. After rotating, the flywheel 20 will be meshed and driven by the second rotating shaft gear 17, the first rotating shaft gear 18, and a gear coaxial with the flywheel 22. When the flywheel 22 reaches a certain rotating speed, a powerful inertial force will be generated. At this time, wood is fed from the feeding hopper 10, and the wood takes advantage of an opportunity to move down to be cut off by the cutting blades 21 that bite each other. After a biting load is excessive, the driving belt 15 will slide to achieve an effect of protecting equipment actively. Compared with a conventional technical solution of reducing speed and increasing torque through a gearbox, the solution is simple in structure, a required shearing force can be generated quickly, the maintenance is convenient, and the cost is low.

It is to be emphasized that the embodiments described in the present disclosure are illustrative and rather than restrictive. Therefore, the present disclosure is not limited to the embodiments described in a specific implementation. Other implementations obtained by those of ordinary skill in the art according to the technical solutions of the present disclosure also fall within the scope of protection of the present disclosure.

What is claimed is:

1. An inertial force wood cutting device, comprising a trailer and a fuel engine which is fixed to the trailer by bolts; a cutting cabin is also fixed to the trailer by bolts; a first rotating shaft and a second rotating shaft are rotatably arranged in the cutting cabin; at least two cutting blades are arranged on the first rotating shaft and the second rotating shaft in a sleeving manner; a second rotating shaft gear and a first rotating shaft gear which are meshed with each other are fixedly arranged at ends of the first rotating shaft and the second rotating shaft through keys; a rotating shaft is also rotatably arranged on the cutting cabin, and the parts, extending out of the cutting cabin, of two ends of the rotating shaft are fixedly connected with flywheels through keys; a gear which is meshed with the first rotating shaft gear is also connected to the rotating shaft through a key; and the flywheel is driven by the fuel engine through a driving belt.

2. The inertial force wood cutting device according to claim 1, wherein a tensioning arm is also hinged to the trailer; a tensioning wheel is rotatably arranged at a front end of the tensioning arm; and a cylindrical side surface of the tensioning wheel is abutted against a back surface of the driving belt.

3. The inertial force wood cutting device according to claim 2, wherein a spring is hooked on the tensioning arm; the other end of the spring is hooked on a protective shell of the flywheel; and the spring tensions the tensioning arm, so that the tensioning wheel is capable of abutting against the back surface of the driving belt.

4. The inertial force wood cutting device according to claim 3, wherein a protective plate is fixed to a front end of a feeding hopper by bolts; and a protective tube with a downward opening is fixed to a tail end of a discharging shelter by bolts.

5. The inertial force wood cutting device according to claim 4, wherein the flywheel includes a hard supporting casing and a flywheel shell which is fixed to the exterior of the hard supporting casing in a sleeving manner; and the flywheel shell is fixed to the hard supporting casing by bolts.

6. The inertial force wood cutting device according to claim 5, wherein a cavity is formed in the flywheel shell; the cavity in the flywheel shell is capable of being filled with counterweight solution; and specifically, the counterweight solution is non-volatile solution which is stable at room temperature.

7. The inertial force wood cutting device according to claim 6, wherein solenoid valves communicated with an inner cavity in the flywheel shell are annularly and fixedly to an outer wall surface of the solenoid valve at intervals; the solenoid valves are controlled to be on and off through remote control signals; during emergency stop, an emergency stop button is pressed down quickly and a signal for opening the solenoid valves is sent out simultaneously, so that the counterweight solution in the flywheel is discharged quickly to reduce an inertial force quickly; and simultaneously, a braking device performs friction braking on a shaft driven to rotate by the flywheel.

8. The inertial force wood cutting device according to claim 7, wherein a plurality of openings are fixedly formed on outer wall surfaces of the solenoid valves; flip plates covering the openings are hinged to the outer wall surface of the flywheel; electromagnets are fixedly arranged at movable ends of the flip plates; the electromagnets are fixed to the outer wall surface of the flywheel through magnetic attraction, and are controlled to be on and off through the remote control signal; and after the emergency stop, the electromagnets lose magnetic attraction, so that the flip plates are thrown away under the action of gravity and then the counterweight solution is thrown away quickly to reduce the inertial force of the flywheel and brake quickly.

9. The inertial force wood cutting device according to claim 8, wherein the driving belt is a flat belt; and a protective shell is fixedly arranged outside the flywheel by bolts.
